(19) United States
(12) Patent Application Publication
(10) Pub. No.: US 2018/0131520 A1
(43) Pub. Date: May 10, 2018

(54) METHOD AND ARRANGEMENT FOR SECURELY INTERCHANGING CONFIGURATION DATA FOR AN APPARATUS

(71) Applicant: Siemens Aktiengesellschaft, München (DE)

(72) Inventors: Hendrik Brockhaus, Unterbiberg (DE); Jens-Uwe Bußer, Neubiberg (DE); Alexander Winnen, Oberhaching (DE)

(21) Appl. No.: 15/572,582

(22) PCT Filed: Jun. 3, 2016
(86) PCT No.: PCT/EP2016/062656

§ 371 Date: Nov. 8, 2017

(30) Foreign Application Priority Data
Jul. 16, 2015 (DE) 10 2015 213 412.1

(51) Int. Cl. H04L 9/32; G06F 21/57; H04L 29/06

(52) U.S. Cl. CPC H04L 9/3234; G06F 21/57; G06F 21/64; H04L 9/3268; H04L 63/0442; H04L 9/3247

(57) ABSTRACT

A method for securely interchanging configuration data between a first apparatus and a second apparatus, including the steps of producing a digital signature for the configuration data for the first apparatus using a piece of security information from the first apparatus, storing the configuration data, the digital signature and a security token in an external memory apparatus, and loading of the configuration data, the digital signature and the security token from the external memory apparatus into the second apparatus is provided. Furthermore, an arrangement for securely interchanging configuration data including an apparatus, and a first memory apparatus detachably connected to the apparatus is also provided.

### CROSS-REFERENCE TO RELATED APPLICATIONS

This application claims priority to PCT Application No. PCT/EP2016/062656, having a filing date of Jun. 3, 2016, based off of German application No. DE 102015213412.1 having a filing date of Jul. 16, 2015 the entire contents of both of which are hereby incorporated by reference.

### FIELD OF TECHNOLOGY

The following relates to a method and an arrangement for securely interchanging configuration data between a first and a second apparatus, particularly apparatuses in an automation installation.

### BACKGROUND

Components installed in automation installations, such as programmable logic controllers (PLC) in production and process engineering, intelligent field devices in power distribution or element controllers in railway engineering, for example, usually also contain individual programming or configuration, which is different for each device, in addition to firmware or software with an identical version for all devices in a series.

To foster simple and rapid replacement of failed devices, for example, these programming or configuration data can additionally be stored in separate external, persistent memories, such an SD card or a USB storage medium, for example. In the event of a defect, a maintenance engineer removes the defective device, takes out the external memory, plugs the latter into a substitute device and connects the latter in the installation. On starting, the substitute device reads in the data from the external memory, takes on the programming and configuration data stored thereon and is immediately operational in the same configuration as the replaced device.

The storage medium may also be permanently installed in the installation, for example in a switchgear cabinet, so that it remains in the installation when a device is removed and, when a device is plugged in/installed, is automatically connected to this device.

An external memory apparatus of this kind that can be plugged into a device or into an apparatus has the advantage that the apparatus is immediately provided with the correct, individual configuration data without administrative effort. When programming and/or configuration data are distributed over a local area network of the installation, for example, it is first necessary to establish where in the installation a new device is located and what data it needs.

On the other hand, programming and configuration data on an external plug-in memory apparatus, which are therefore detachably connectable to a device or an apparatus, can have the disadvantage that an attacker who has physical access to the detachable memories or physical access to the apparatus can manipulate these data more easily.

### SUMMARY

An aspect relates to allowing manipulation-proof interchange of configuration data between apparatuses.

The method according to embodiments of the invention for securely interchanging configuration data between a first and a second apparatus comprises the steps of:
creating a digital signature for the configuration data of the first apparatus using a piece of security information of the first apparatus,
storing the configuration data, the digital signature and a security token in an external memory apparatus, and
loading the configuration data, the digital signature and the security token from the external memory apparatus into the second apparatus.

The signature of the configuration data of the first apparatus can be used to check the integrity of the data. The means required for this purpose are provided to the second apparatus by virtue of the security token that is loaded into the second apparatus together with the signed configuration data. In the method, the external memory apparatus is used as a transmission medium for this information. It is therefore possible to ensure that the data on the external memory apparatus have not been altered. This ensures that the current configuration information is present on the external memory apparatus at any time. This particularly allows a replacement of the apparatus with a second apparatus to involve the current configuration of the first apparatus being transmitted to the second apparatus. Therefore, no additional administrative effort arises, for example by virtue of a central configuration server in which an update to the configuration data needs to be reported and the correspondingly updated configuration data need to be retrieved.

In one advantageous embodiment, the configuration data are checked by the second apparatus by means of the signature and the security token of the first apparatus and are used in the event of a successful check.

This ensures that only unaltered configuration data are loaded into the second apparatus and therefore no subsequently introduced malicious code is inserted into the configuration data. This is advantageous particularly when an external memory apparatus is used, since the latter can easily be removed from an apparatus and plugged back in following a manipulation.

In one advantageous embodiment, a digital signature for the configuration data is created in the second apparatus, after the loading and checking of the configuration data by the second apparatus, using a piece of security information of the second apparatus, and said digital signature is stored on the external memory apparatus.

This now allows the second apparatus to update configuration data that have changed again on the external memory apparatus.

In one advantageous embodiment, the piece of security information is a private key and the security token is a digital certificate.

The private key and the digital certificate are in this case elements of an asymmetric cryptographic method, for example in accordance with a public key infrastructure. In this case, the private key has an explicitly associated public key that is included in the digital certificate. Data are encrypted using the private key in this case and can be decrypted using the public key. The check on the digital certificate appended to the configuration data as a security token also allows the authenticity of the configuration data to be checked by virtue of the certificate on hand from the first apparatus being traced back to a certificate that is already on hand in the second apparatus, for example a trustworthy root certificate of the manufacturer that is rooted in the firmware. A trustworthy root certificate of this kind, particularly from the manufacturer, exists particularly in the case of devices from the same manufacturer. If a device from a different manufacturer than the first apparatus is used as substitute device, that is to say as second apparatus, then it is necessary to ensure that a suitable certificate, for example the root certificate of the manufacturer of the first apparatus, is available in the second apparatus.

If there is already a first digital signature for at least one first subset of the configuration data, then in one advantageous embodiment a second digital signature is created just for a subset of the configuration data for which there is not yet a signature, using a piece of security information of the first apparatus, or a digital signature is created for all the subsets of the configuration data and the signatures that are already present, using a piece of security information of the first apparatus.

In both cases, it is ensured that it is not the case that any subset of the configuration data is without a digital signature and therefore the integrity and authenticity thereof cannot be checked. If such unsigned subsets of the configuration data are accepted by a second apparatus, for example, then misconfiguration or manipulation of the second apparatus can become possible.

In one advantageous embodiment, the configuration data are stored on the external memory apparatus in encrypted fashion. However, this requires an appropriate key to be on hand in the firmware of a first and a second apparatus, for example, or such a key to be able to be requested from a central component.

The arrangement according to embodiments of the invention for securely interchanging configuration data comprises an apparatus having configuration data of the apparatus, a piece of security information for at least one asymmetric cryptographic method, a cryptographic computation unit, and also a memory apparatus detachably connected to the apparatus, wherein the cryptographic computation unit is set up to create a digital signature for the configuration data and to store the configuration data, the digital signature and a security token of the piece of security information in the external memory apparatus.

In such an arrangement, when the apparatus is replaced, the external memory apparatus can be detached, for example removed, and connected to a substitute apparatus, which therefore takes on the exact same configuration that the replaced apparatus had. Therefore, the administrative effort when replacing an apparatus is minimized and misconfigurations are avoided.

In one advantageous embodiment, the digital signature is created using a private key of the piece of security information of the apparatus, and the security token is present as a digital certificate having a public key of the apparatus.

The use of a digital certificate allows not only the integrity of the configuration data but also the authenticity thereof to be checked, and therefore makes it possible to ensure that the configuration data are issued by the certificate owner cited in the certificate.

In one advantageous embodiment, the cryptographic computation unit is set up to follow a change in the configuration data in the apparatus by computing a new digital signature and by storing the changed configuration data and the new digital signature on the external memory apparatus.

In one advantageous embodiment, the cryptographic computation unit is set up to read in secure configuration data from the external memory apparatus, to check the secure configuration data by means of the digital signature and the security token that are included in the secure configuration data, and to use the secure configuration data in the apparatus in the event of a successful check.

The signature can ensure that no manipulated data are transferred to the second apparatus.

In one advantageous embodiment, the cryptographic computation unit is set up to create a digital signature for the secure configuration data using a piece of security information of the apparatus and to store said digital signature on the external memory apparatus.

This allows the configuration data of the apparatus to be able to be updated at any time and allows said configuration data to be stored on the external memory apparatus in secure fashion.

In one advantageous embodiment, the cryptographic computation unit is set up to follow a renewal of the certificate of the apparatus by computing a new digital signature and by storing the new digital signature and the renewed certificate on the external memory apparatus.

A computer program product (non-transitory computer readable storage medium having instructions, which when executed by a processor, perform actions) according to the invention can be loaded directly into a memory of a digital computer and comprises program code sections that are suitable for performing the aforementioned method steps. Accordingly, a data storage medium according to embodiments of the invention is claimed that stores said computer program product.

### BRIEF DESCRIPTION

Some of the embodiments will be described in detail, with reference to the following figures, wherein like designations denote like members, wherein:

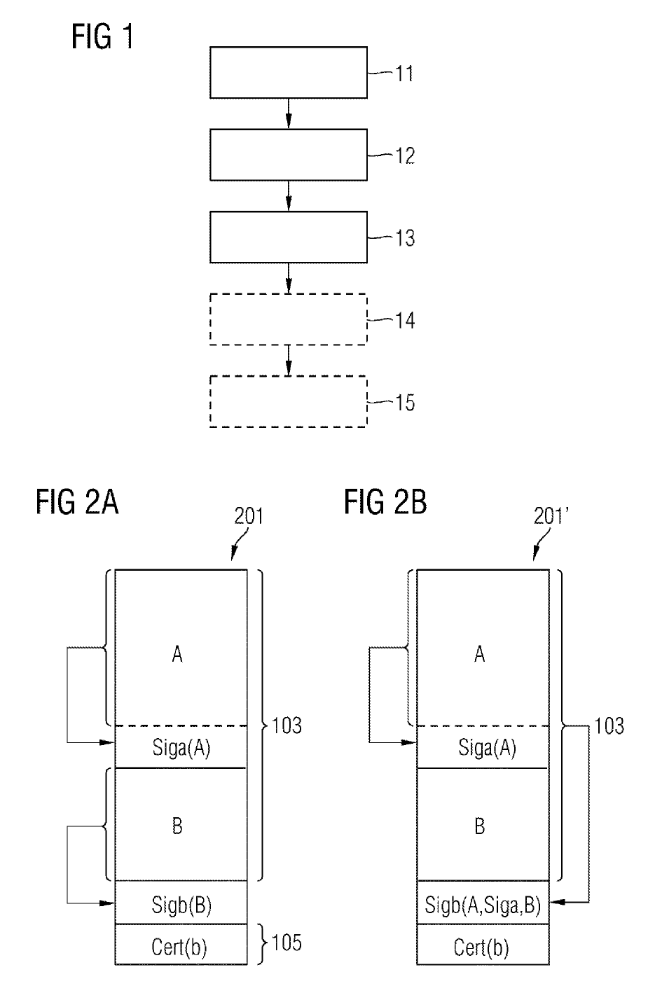

FIG. 1 depicts a flowchart of an exemplary embodiment of the method;

FIG. 2A depicts a first example of configuration data that have been created using the method;

FIG. 2B depicts a second example of configuration data that have been created using the method;

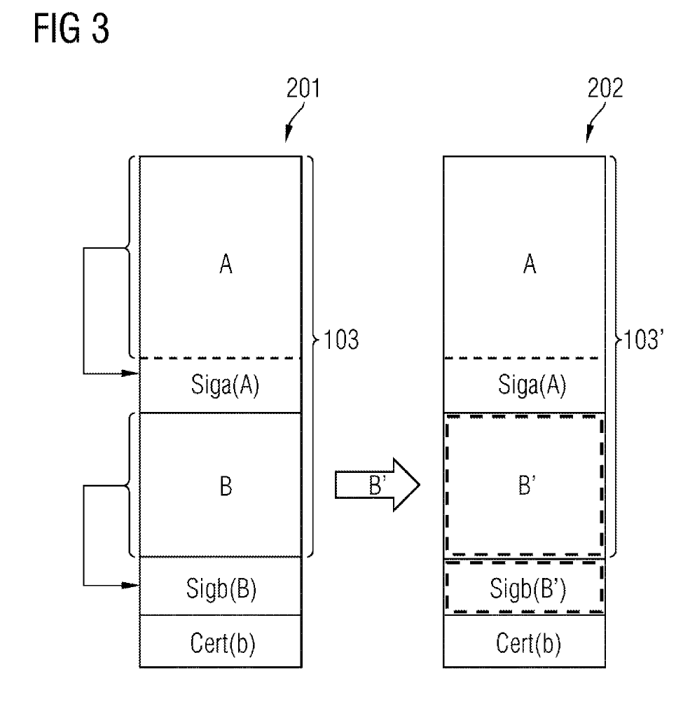

FIG. 3 depicts a schematic depiction of configuration data that are changed when configuration data are updated;

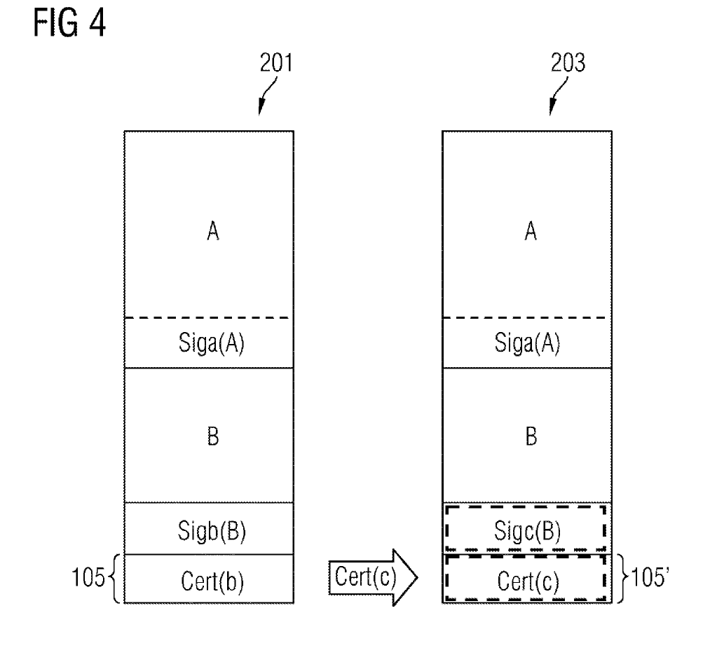

FIG. 4 depicts a schematic depiction of configuration data that are generated when the memory apparatus is swapped from a first apparatus to a second apparatus; and

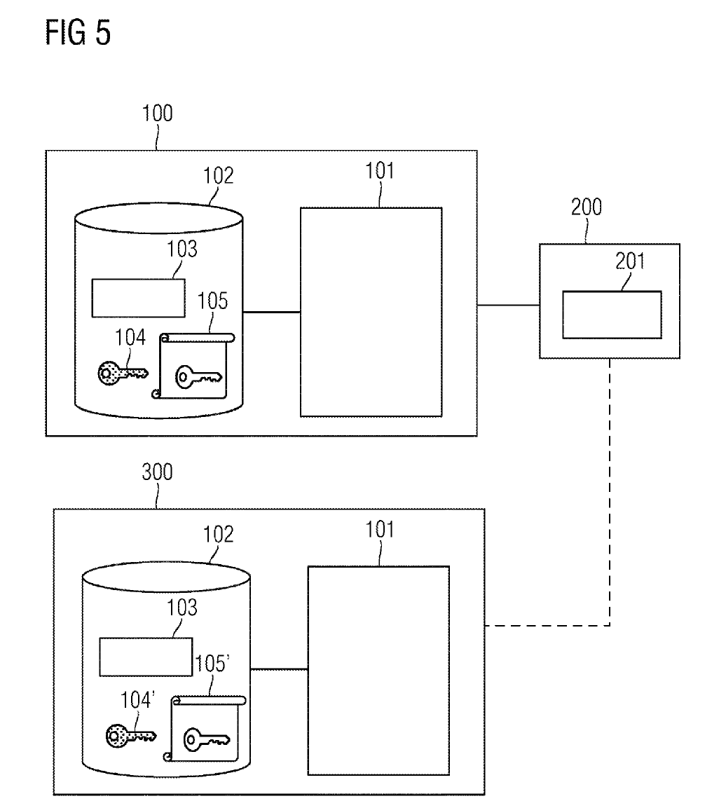

FIG. 5 depicts a block diagram of an exemplary embodiment of an arrangement.

Mutually corresponding parts are provided with the same reference symbols in all the figures.

### DETAILED DESCRIPTION

FIG. 1 shows a method for securely interchanging configuration data between a first and a second apparatus that in particular carry out the same task and are identical or very similar devices from a series. Such apparatuses are intelligent field devices, for example, that are installed in the same series and version in an automation installation, for example, but perform different tasks. Therefore, the individual field devices differ only in some of their configuration data. In order to simplify the complexity when such a device is replaced by a substitute device, configuration data on an external memory apparatus, such as an SD card or a USB storage medium connected to a device during normal operation of said device, for example, are used. A detachable memory apparatus of this kind is removed from the apparatus during replacement and connected to the second apparatus that replaces the first. So as to ensure in this case that the external memory apparatus has not been manipulated, and the configuration data have not been changed, during replacement, a piece of security information for an asymmetric encryption method that is usually present in such an apparatus is now used for safety. Such a piece of security information of the first apparatus is a private cryptographic key of the first apparatus, for example. Subsequently, the configuration data are stored together with the digital signature and a security token in the external memory apparatus. By way of example, a security token is a digital certificate that includes not only an identifier for the apparatus but also a public key matching the private key that has been used for signing. When configuration data are interchanged, the external memory apparatus is now detached from the first apparatus and connected to a second apparatus and the configuration data are loaded into the second apparatus. The configuration data can therefore be checked for their authenticity and integrity.

When the second apparatus starts, it checks the configuration data by means of the digital signature and the security token that has been appended to the configuration data. This is shown in dashed lines as method step 14. Advantageously, the second apparatus uses the configuration data only in the event of a successful check 15. It is therefore possible for a change of the configuration data on the external memory apparatus to be checked and for the uploading of such manipulated configuration data to be avoided.

In one advantageous embodiment, the successful check on the authenticity and integrity of the configuration data in the second apparatus is preceded by only some of the configuration data being used by the second apparatus, for example in order to load further data via a network, and the check is carried out or repeated later.

The authenticity of the data is checked by virtue of the security token on hand, for example a certificate already on hand from the first device, being traced back to a trustworthy root certificate rooted in the firmware of the second apparatus. Usually, apparatuses in the same series and in the same version from a manufacturer are equipped with a standard certificate of the manufacturer. Therefore, such a root certificate of the manufacturer is suitable for securing the configuration data. Following a successful check, the second apparatus can use a piece of security information of its own to perform a new signature for the data and to replace the signature and associated security token on the eternal memory apparatus.

The first and also the second apparatus can preferably use a signature certificate as a security token for signing the data on the external memory apparatus. Such a signature certificate can also be used for signing measurement or logging data or else control commands. It is not necessary to use a separate certificate for the digital signature of the configuration data. If the apparatus has no such certificate, it is also possible to use another, arbitrary certificate in principle, for example for setting up a secure TLS connection. Such a certificate is not necessarily provided for such data signature, but can nevertheless be used, since this can easily be taken into consideration for the implementation of the function for use and checking of the certificate.

FIGS. 2A and 2B depict different options for the signature of configuration data A, B. Subset A of the configuration data is configuration data that have been allocated to the apparatus centrally during project planning, for example. Subset B of the configuration data is apparatus-specific calibration data that have been generated individually on startup of the apparatus, for example. Subset A of the configuration data is signed by means of a digital signature, for example of a project planner, both in FIG. 2A and in FIG. 2B. In FIG. 2A, only subset B of the configuration data is signed by means of the piece of security information of the first apparatus B, and an applicable security token Cert(b), also denoted by reference 105, is attached. In the variant depicted in FIG. 2B, a signature Siga(A) is produced for the entire set of configuration data 103 on hand, in this case subset A, and a signature Sigb(A, Siga(A), B) or Sigb(103) is produced for subset A and for subset B, and again the security token Cert(b) of the apparatus is appended.

FIG. 3 depicts configuration data 201 that are created by a first apparatus and stored in the external memory apparatus as configuration data 201. If at least some of the configuration data change, see changed configuration data 13′, then they are updated, as depicted by the arrow in this case. Moreover, a signature Sigb(B′) is computed for the changed configuration data 13′. The areas depicted in dashed lines are changed in comparison with the configuration data 201 in resultant changed configuration data 203. These are in particular the updated subset 13′ of the configuration data and an updated digital signature Sigb(B′).

FIG. 4 shows how the configuration data 201 of a first apparatus change when the first apparatus is provided with a new security token, particularly a new certificate Cert(c). This may be the case after the preceding certificate Cert(b) has expired, for example. On the external memory apparatus, the security token is then replaced by the new security token Cert(c), and a digital signature is generated for subset B of the configuration data using security information in accordance with the security token Cert(c) and is added to the configuration data.

The same configuration data 203 are obtained when the external memory apparatus is connected to a second apparatus and, after the signature and the security token are checked, the configuration data, in this case subset B, are signed using the security information and the security token of the second apparatus and both items of data are appended. In this case, the security token Cert(c) then corresponds to the security token or the digital certificate of the second apparatus.

FIG. 5 now shows an arrangement having a first apparatus 100 that is connected to an external memory apparatus 200. The memory apparatus 200 may be detachably connected to the first apparatus 100 via a USB interface, for example. Similarly, secure digital memory cards, also called SD cards for short, can be used as an external memory apparatus. Such a card can also be inserted into and removed again from an appropriate slot in the first apparatus 100, for example. The first apparatus comprises an internal memory 102 on which the memory data 103, particularly subsets A, B from FIGS. 2, 3 and 4, are stored. Such a first apparatus 100 usually comprises security information for at least one asymmetric cryptographic method, for example a signature method, particularly a private key 104 and also a security token 105, which comprises a public key belonging to the private key 104 as a digital certificate, for example, and also comprises a device identifier of the apparatus 100 and is signed by a credible center. This credible center is represented by a root certificate.

The internal memory 102 is connected to a cryptographic computation unit 101. The cryptographic computation unit 101 signs the configuration data 103 using the private key 104, that is to say that a digital signature is formed. Subsequently, the configuration data 103, the digital signature and the security token 105 are stored on the external memory apparatus as configuration data 201. If the configuration data of the first apparatus 100 change, then the changed configuration data are signed again and are updated on the external memory apparatus 200, as already described.

If the device 100 is replaced by a second apparatus 300, then the external memory apparatus 200 is detached from the first apparatus and connected to the second apparatus 300, see connection in dashed lines. A second apparatus 300 differs from the first apparatus particularly by virtue of an apparatus-specific private key 104′ of the second apparatus and a correspondingly different security token 105′ or digital certificate 105′.

The second apparatus 300 now reads the configuration data 201 from the external memory apparatus 200, and checks the digital signature using the included public key that is in the certificate. The authenticity of the configuration data is checked by tracing back the digital certificate 105 to a common root certificate. If both the authenticity and integrity of the configuration data are confirmed, the second apparatus 300 loads the configuration data into the internal memory 102 and therefore has the exact same configuration 103 as the first apparatus 100. Subsequently, the cryptographic computation apparatus 101 generates a digital signature for the configuration data 103 using the private key 104′ of the second apparatus 300 and stores said digital signature on the external memory apparatus together with the certificate 105′ of the second apparatus 300. It is therefore possible for the second apparatus again to update its own configuration at any time on the external memory apparatus 200.

Security tokens or operative certificates 105, 105′ that are on hand on the first and second apparatuses 100, 300, for example for a measurement data signature, communication or the like, can also be used for securing the externally stored configuration data. This achieves protection for the configuration data on the external memory apparatus 200 against manipulation in the event of physical access. Furthermore, no additional administrative effort is required for a maintenance engineer or for a superordinate configuration server, for example, in order to provide a substitute apparatus having the exact same configuration as the apparatus to be replaced.

All the features described and/or depicted can be advantageously combined with one another within the scope of the invention. The invention is not restricted to the exemplary embodiments described.

1. A method for securely interchanging configuration data between a first apparatus, connected to an external memory apparatus, and a second apparatus, comprising:
creating a digital signature for the configuration data of the first apparatus using a piece of security information of the first apparatus;
storing the configuration data, the digital signature and a security token in an external memory apparatus;
loading the configuration data, the digital signature and the security token from the external memory apparatus into the second apparatus, wherein the second apparatus checks the configuration data by means of the digital signature and the security token of the first apparatus; and
creating a digital signature for the configuration data in the second apparatus using a piece of security information of the second apparatus and storing the digital signature for the configuration data of the second apparatus on the external memory apparatus.

2. The method as claimed in claim 1, wherein a change in the configuration data in the first apparatus is followed by a new digital signature being ascertained and a changed configuration data and the new digital signature being stored on the external memory apparatus.

3. The method as claimed in claim 1, further comprising: using the configuration data in an event of a successful check.

4. The method as claimed in claim 1, wherein the piece of security information is a private key and the security token is a digital certificate.

5. The method as claimed in claim 1, wherein there is already a first digital signature for at least one first subset of the configuration data, and
a second digital signature is created just for a second subset of the configuration data for which there is not yet a signature, using a piece of security information of the first apparatus, or a digital signature is created for all the subsets of the configuration data and the signatures that are already present, using a piece of security information of the first apparatus.

6. The method as claimed in claim 1, wherein the configuration data is stored on the external memory apparatus in an encrypted fashion.

7. An arrangement for securely interchanging configuration data between a first apparatus and a second apparatus comprising:
a first apparatus, having configuration data of the first apparatus a piece of security information for at least one asymmetric cryptographic method and a cryptographic computation unit;
a second apparatus having a cryptographic computation unit; and an external memory apparatus detachably connectable to the first apparatus and the second apparatus;
wherein the cryptographic computation unit of the first apparatus is set up to create a digital signature for the configuration data, and to store the configuration data, the digital signature and a security token of the piece of security information in the external memory apparatus, wherein the cryptographic computation unit of the second apparatus is set up:
to read in stored configuration data from the external memory apparatus,
to check the stored configuration data by means of the digital signature and the security token that are included in the secure configuration data, and
to create a digital signature for the configuration data in the second apparatus using a piece of security information of the second apparatus and to store the digital signature on the external memory apparatus.

8. The arrangement as claimed in claim 7, wherein the digital signature is created using a private key of the piece of security information of the first or second apparatus, and the security token is a digital certificate having a public key of the first apparatus or second apparatus.

9. The arrangement as claimed in claim 7, wherein the cryptographic computation unit is set up to follow a change in the configuration data in the first apparatus by ascertaining a new digital signature and by storing the changed configuration data and the new digital signature, Sigb on the external memory apparatus.

10. The arrangement as claimed in claim 7, wherein the cryptographic computation unit is set up:
to use the stored configuration data in the first apparatus in the event of a successful check.

11. The arrangement as claimed in claim 7, wherein the cryptographic computation unit is set up to follow a renewal of the certificate of the first apparatus by computing a new digital signature and by storing the new digital signature and the renewed certificate on the external memory apparatus.

12. A computer program product, comprising a computer readable hardware storage device having computer readable program code stored therein, said program code executable by a processor of a computer system to implement a method as claimed in claim 1.

13. A data storage medium that stores the computer program product as claimed in claim 12.
